(19) United States
(12) Patent Application Publication
(10) Pub. No.: US 2010/0012027 A1
(43) Pub. Date: Jan. 21, 2010

(54) Device for injecting liquid precursors into a chamber in pulsed mode with measurement and control of the flowrate

(75) Inventors: Frederic Poignant, Pignan (FR); Samuel Bonnafous, Montpellier (FR); Jean-Manuel Decams, Montpellier (FR); Herve Guillon, Montpellier (FR)

Correspondence Address: OLIFF & BERRIDGE, PLC, P.O. BOX 320850, ALEXANDRIA, VA, 22320-4850, US

(73) Assignee: QUALIFLOW-THERM, MONTPELLIER FRANCE (FR)

(21) Appl. No.: 11/659,337

(22) PCT Filed: Aug. 5, 2005
(86) PCT No.: PCT/FR05/02049

§ 371 Date: Jan. 26, 2009

(30) Foreign Application Priority Data
Jun. 8, 2004 (FR) 0408704

(51) Int. Cl. B05C 11/10

(52) U.S. Cl. 118/692

(57) ABSTRACT

A device for injecting into a chamber at least one precursor comprises at least one tank containing the precursor, means for keeping the tank at a higher pressure than that of the chamber, and at least one injector connected to the tank. It also comprises a device for measuring the mean flowrate, arranged between the tank and the injector and a mechanical low-pass filter arranged between the device for measuring the flowrate and the injector. The control circuit comprises outputs respectively connected to the tank and to the injector for controlling said pressure and/or the injection time and/or the injection frequency, in such a way as to periodically inject droplets of precursor into the chamber. The control circuit also comprises a regulation input connected to the output of the device for measuring the mean flowrate, in such a way as to control said pressure and/or the injection time and/or the injection frequency in order to keep the mean flowrate at a predetermined set-point.

### BACKGROUND OF THE INVENTION

The invention relates to a device for injecting into a chamber at least one liquid precursor or one precursor in solution of an element to be deposited on a support arranged in the chamber, said device comprising:
at least one tank containing the precursor,
means for keeping the tank at a higher pressure than that of the chamber,
at least one injector connected to the tank,
a control circuit comprising outputs respectively connected to the tank and to the injector to control said pressure and/or the injection time and/or the injection frequency in such a way as to periodically inject droplets of precursor into the chamber.

### STATE OF THE ART

In the field of chemical vapor deposition (CVD, with continuous or pulsed gas flows or with a combination of pulsed and continuous gas flows) or of atomic layer deposition (ALD), the devices for entering the elements to be deposited or the precursors of said elements into the deposition chamber are more and more often constituted by devices for injecting liquid droplets. The liquid droplets are injected either directly into the deposition chamber or into a thermostated chamber coupled with the deposition chamber.

Such injection devices enable a spray to be formed constituted by fine droplets evaporating without the precursor or the element to be deposited having previously come into contact with the thermostated chamber or with the reaction chamber. This limits the risks of fouling and generation of particles. These devices also enable new types of precursors to be used, for example organo-metallic, liquid or solid elements which may be not very volatile and are often difficult to implement, as they are by nature chemically or thermally unstable. These precursors can be used pure when they are in liquid form or dissolved in a solvent when they are in liquid or solid form. New materials, constituted by elements, which are for example transition metals, alkaline earths or lanthanides, can thus be obtained by CVD and/or ALD.

The Patent Application EP-A-0730671 describes for example a device for entering precursor of elements to be deposited on a substrate into a CVD chamber by discontinuous injection of droplets. As represented in FIG. 1, the injection device 1 comprises a tank 2 containing a precursor in liquid form or in solution and connected to an injector 3. The injection device 1 also comprises means for keeping the tank 2 at a higher pressure than that of the chamber, the pressure P in the tank being for example maintained by injecting a gas under pressure, and more particularly at a predetermined pressure P_{gas} also called thrust pressure, into the top part of the tank 2. Injection is controlled by a control circuit 4 whereby droplets of a predetermined volume of the precursor can be periodically injected into the deposition chamber, by adjusting the opening time tᵢₙⱼ of the injector, the injection frequency Fᵢₙⱼ or the gas pressure P.

Such devices operate in open loop. Thus, for given experimental data such as the type of precursor, the temperature of the chamber, the temperature of the liquid to be injected, or the thrust pressure, the injector 3 is for example controlled such as to open periodically, i.e. at a certain frequency Fᵢₙⱼ with a previously set opening time tᵢₙⱼ, in such a way as to obtain droplets of a given volume. On outlet from the injector 3, the liquid is then pulsed at the control frequency Fᵢₙⱼ.

The level of reproducibility of such devices does however depend to a great extent on the stability of the experimental conditions such as the temperature, the thrust pressure, the pressure in the chamber. It also depends on the reproducibility of operation of the injector 3, itself dependent on its temperature, on the level of fouling of the pipe arranged between the tank 2 and the injector 3 or of the injection head. Moreover, in certain cases, it is experimentally observed that the mean liquid flowrate can vary several percent over a few tens of minutes without the injection control parameters having been modified.

### OBJECT OF THE INVENTION

The object of the invention is to obtain a device for injecting into a chamber at least one liquid precursor or one precursor in solution of an element to be deposited on a support arranged in the chamber, which device remedies the shortcomings mentioned above and is more particularly reliable and reproducible.

According to the invention, this object is achieved by the fact that the device comprises:
a device for measuring the mean flowrate, arranged between the tank and the injector,
and a mechanical low-pass filter having a predetermined transfer function and arranged between the device for measuring the flowrate and the injector,
   and by the fact that the control circuit comprises a regulation input connected to the output of the device for measuring the mean flowrate in such a way as to control said pressure and/or the injection time and/or the injection frequency in such a way as to keep the mean flowrate at a predetermined set-point.

According to a first development of the invention, an additional mechanical low-pass filter is arranged between the tank and the device for measuring the flowrate.

According to a second development of the invention, the mechanical low-pass filter is formed by a pulse damper.

According to another development of the invention, the mechanical low-pass filter is a restriction that is constituted by a portion of a pipe arranged between the tank and the injector, said portion having a smaller transverse cross-section than that of the rest of the pipe in such a way as to form a throttling.

According to another development of the invention, the mechanical low-pass filter is constituted by a connection designed to form a buffer volume.

According to a preferred embodiment, the control circuit comprises a correction circuit connected to the regulation input and taking account of the transfer function of the mechanical low-pass filter.

According to another particular embodiment, the device comprises a pressure regulation circuit comprising at least first and second inputs respectively connected to the output of the control circuit associated with the tank and to a device for measuring the pressure in the tank.

According to another feature, the pressure regulation circuit comprises at least first and second outputs respectively connected to an inlet valve and an outlet valve respectively controlling inlet and outlet of a compressed gas to and from the tank.

### BRIEF DESCRIPTION OF THE DRAWINGS

Other advantages and features will become more clearly apparent from the following description of particular embodiments of the invention given as non-restrictive examples only and represented in the accompanying drawings, in which:

FIG. 1 represents in block diagram form a device for injecting precursors according to the prior art.

FIG. 2 represents in block diagram form a device for injecting precursors according to the invention.

FIGS. 3 and 4 respectively illustrate variations of instantaneous and mean flowrates versus time in a device according to the prior art and in a device according to the invention.

FIG. 5 schematically represents a particular embodiment of a device according to the invention.

FIG. 6 illustrates variations of instantaneous and mean flowrates versus time in a device according to the invention, when a change of injection frequency occurs.

FIG. 7 schematically represents a particular embodiment of the means for regulating the pressure in the tank of a device according to the invention.

FIG. 8 schematically represents a variation of a particular embodiment of a device according to FIG. 2.

### DESCRIPTION OF PARTICULAR EMBODIMENTS

According to the invention, periodic injection into an chamber such as a CVD or ALD deposition chamber or a thermostated chamber coupled with said deposition chamber, of at least one liquid precursor or one precursor in solution of an element to be deposited on a support arranged in the chamber, is achieved by an injection device 1 such as the one represented in FIG. 2. The injection device 1 comprises a tank 2 connected to an injector 3 by means of a pipe 5 designed to feed the injector with precursor. The tank 2 containing the precursor is kept, by any type of means, at a higher pressure P than that of the chamber into which the precursor is injected. The pressure P in the tank 2 is for example kept higher than that of the chamber by controlled injection of a compressed gas into the tank 2. The pressure at which the compressed gas is injected into the tank 2 is also called the thrust pressure P_{gas}.

A flowrate measuring device or flowmeter 6 is arranged between the tank 2 and the injector 3 in such a way as to measure the mean flowrate (Q^{m}ₘₑₐₛ) upstream from the injector 3. The flowmeter 6 is for example a mass liquid flowmeter such as a Coriolis effect flowmeter or a thermal flowmeter, or a volumetric liquid flowmeter, with instantaneous read-out, or a flowmeter based on measurement of the pressure difference at the boundaries of a restriction in which the liquid precursor flows.

Such flowmeters are however at present not suited to the injection frequencies used. Thus, for a relatively low injection frequency, for example 5 Hz, the signal from the flowmeter and the pressure upstream therefrom are pulsed at the injection frequency. Under these conditions, even with a pressure regulation system, the signal measured by the flowmeter oscillates greatly and is liable to exceed the predetermined maximum measurement value and to stray outside the linearity range of the flowmeter. In this case, the mean value of the measured flow is no longer representative of the mean flow in the pipe 5. Moreover, the behaviour of periodic injection devices in pulsed mode of liquid precursors or precursors in solution, and more particularly the variation of the mean flow of liquid to be injected from one deposition to the other (reproducibility), can not be anticipated and corrected. It is generally highlighted indirectly and a posteriori by analyzing for example the thickness of the thin layers obtained by CVD or ALD. Likewise, for these systems, the variation of the mean flow of liquid to be injected in the course of a deposition (repeatability) can not be anticipated or corrected and can only be highlighted a posteriori by analyzing for example, in the case of depositions of multimetallic materials obtained from homometallic precursors injected into the chamber via different injection lines, the stability of the composition of the layer over the thickness thereof.

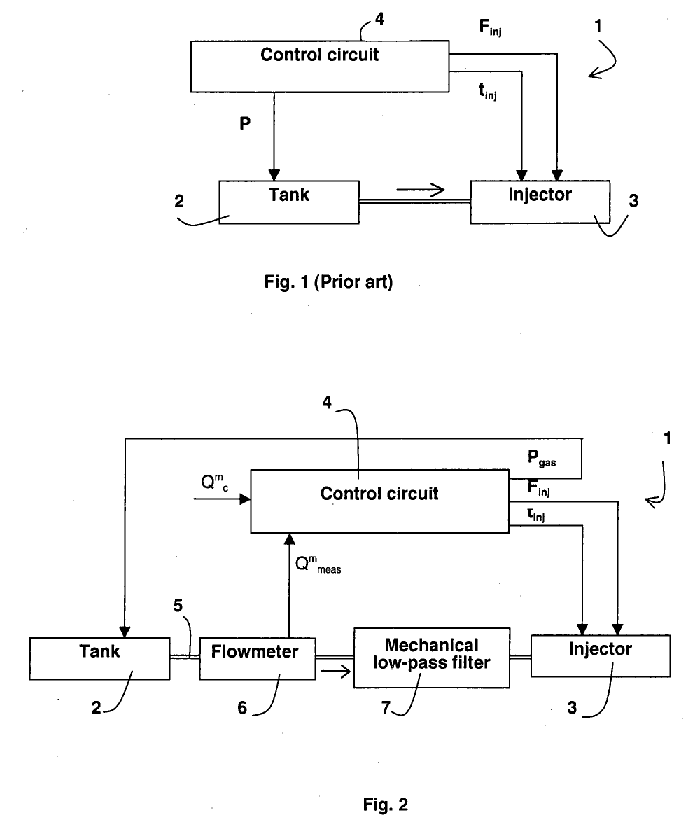

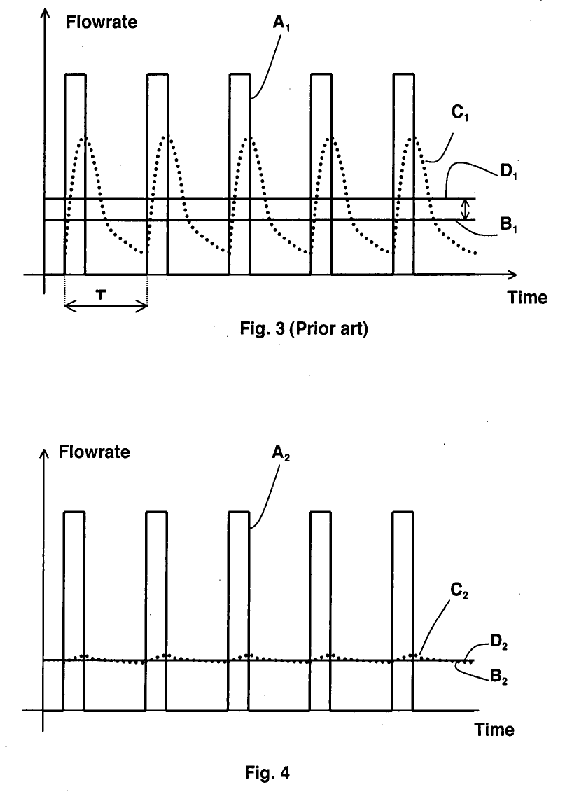

For illustration purposes, FIG. 3 represents flowrate variations versus time of an injection device such as the one represented in FIG. 1, with a flowmeter arranged between the tank 2 and the injector 3. The curves A₁ to D₁ respectively represent the variation versus time:
of the instantaneous flowrate at the level of the injector (A₁),
of the mean flowrate at the level of the injector over an injection period T (B₁),
of the instantaneous flowrate measured by the flowmeter (C₁)
and of the flowrate measured by the flowmeter and integrated over an injection period T (D₁).

The curve A₁ is made up of a succession of rectangular pulses of predetermined period whereas the curve C₁, in a dotted line, is made up of a succession of pulses substantially dampened by the presence of the flowmeter. The curves B₁ and D₁ correspond respectively to mean values that are substantially constant in time but different from one another. This therefore illustrates the difficulty of measuring the mean flowrate correctly, with periodic injection devices, even when the flowrate is integrated over an injection period.

As represented in FIG. 2, the injection device 1 further comprises a mechanical low-pass filter 7 with a known transfer function H₁. The mechanical low-pass filter is arranged between the flowmeter 6 and the injector 3 and has the function of transforming the instantaneous flowrate at the level of the injector 3, i.e. downstream from the low-pass filter, into a substantially constant mean flowrate at the level of the flowmeter 6, i.e. upstream from the low-pass filter. This enables a reliable measurement of the mean flowrate at the level of the flowmeter 6 to be obtained, as illustrated in FIG. 4 in which flowrate variations versus time of an injection device such as the one represented in FIG. 2 are represented. The curves A₂ to D₂ respectively represent the variation versus time:
of the instantaneous flowrate at the level of the injector (A₂),
of the mean flowrate at the level of the injector over an injection period T (B₂),
of the instantaneous flowrate measured by the flowmeter (C₂)
and of the flowrate measured by the flowmeter and integrated over an injection period T (D₂).

Like the curve A₁ of FIG. 3, the curve A₂ is made up of a succession of rectangular pulses of predetermined period. The curve C₂ on the other hand, in a dotted line, is made up of a succession of pulses that are greatly dampened with respect to the curve C₁ of FIG. 3. In addition, unlike the curves B₁ and C₁, the curves B₂ and D₂ are superposed and correspond to a substantially constant single mean value and the flowrate values of the strongly dampened curve C₂ are close to the mean value of the curves B₂ and D₂. The presence of the mechanical low-pass filter therefore enables the mean flowrate to be measured reliably at the level of the flowmeter, making the latter substantially constant, without any marked oscillations.

The mechanical low-pass filter 7, also called mechanical element acting as low-pass filter, is for example formed by a pulse damper and/or by a restriction which is formed by a portion of the pipe 5 the transverse cross-section whereof is smaller than the rest of the pipe 5 in such a way as to form a throttling and/or a branch connection designed to form a buffer volume. The mechanical low-pass filter 7 preferably has a low cut-off frequency with respect to the control frequency of the injector Fᵢₙⱼ, said cut-off frequency being determined by the choice of the mechanical low-pass filter and by the choice of the dimensions of the tank 2 and pipe 5.

Periodic injection of droplets of precursor into the chamber is controlled by a control circuit 4. The control circuit 4 comprises outputs respectively connected to the tank and to the injector to control at least one of the control parameters chosen from the pressure P in the tank and more particularly the thrust pressure P_{gas} on which the pressure P in the tank depends, the injector opening time tᵢₙₜ, also called injection time, and the injection frequency Fᵢₙⱼ. The control circuit 4 further comprises a regulation control input connected to the output of the flowmeter 6 in such a way as to control at least one of the control parameters, i.e. the thrust pressure P_{gas} and/or the injection time tᵢₙⱼ and/or the injection frequency Fᵢₙⱼ, so that the mean flowrate measured Q^{m}ₘₑₐₛ by the flowmeter 6 no longer oscillates and corresponds to a flowrate setpoint Q^{m}_{c}(t) which can for its part vary with time. The mean injection flowrate is thereby regulated around a predetermined set-point Q^{m}_{c} from measurement of the flowrate Q^{m}ₘₑₐₛ.

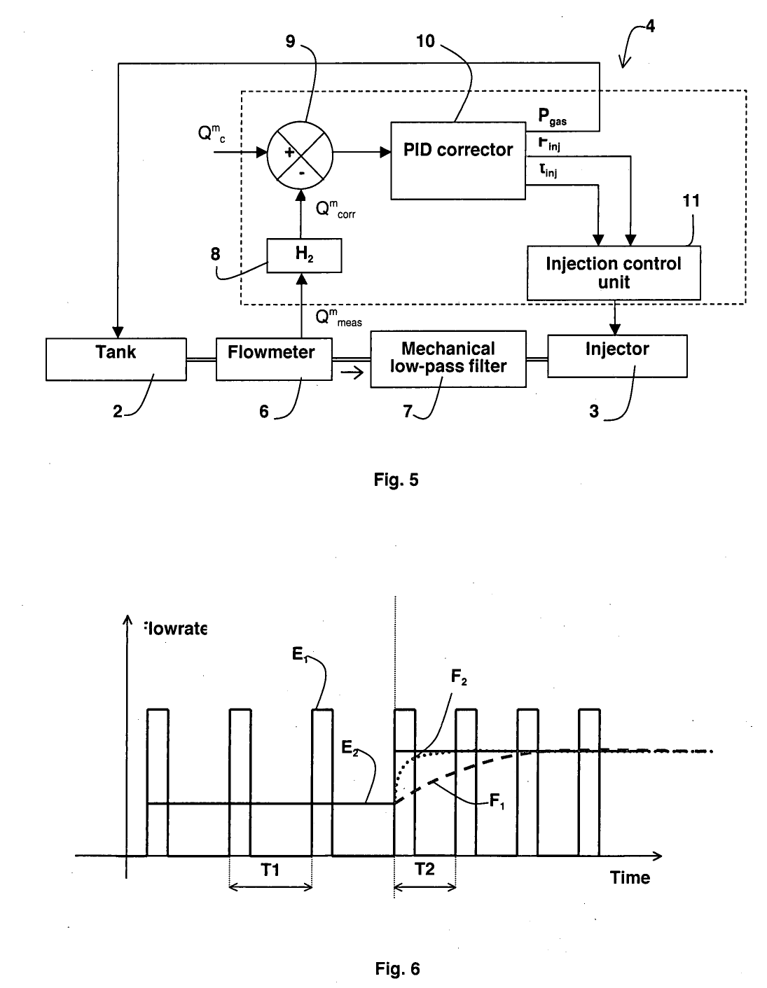

In a particular embodiment represented in FIG. 5, the control circuit 4 comprises a correction circuit 8 connected to the regulation input and taking account of the transfer function H₁ of the mechanical low-pass filter 7. The correction circuit 8 thus enables a corrected mean flowrate value Q^{m}_{corr} to be obtained, equal to H₂×Q^{m}ₘₑₐₛ, where H₂ is a correction factor of the correction circuit 8 dependent on the mechanical low-pass filter transfer function H₁. In conventional manner, a logic circuit 9 by difference supplies, on output, an error signal between the set-point Q^{m}_{c} and the corrected mean flowrate value Q^{m}_{corr}. The error signal is then corrected by a corrector 10, for example a PID (Proportional Integral Derivative) corrector, in such a way as to control at least one of the control parameters P_{gas}, tᵢₙⱼ and Fᵢₙⱼ. The control parameters tᵢₙⱼ and Fᵢₙⱼ of the injector 3 then act on an injection control unit 11 an output whereof is connected to the injector 3.

A device such as the one represented in FIG. 2, with a mechanical low-pass filter 7 and a control circuit 4 as represented in FIG. 3, thereby enables a reliable and reproducible periodic injection to be obtained. For example purposes, FIG. 6 represents the variations versus time respectively of the instantaneous flowrate at the level of the injector (Curve E₁), of the mean flowrate over an injection period at the level of the injector (Curve E₂), of the instantaneous flowrate measured Q^{m}ₘₑₐₛ by the flowmeter (Curve F₁), and of the corrected flowrate Q^{m}_{corr} from the flowrate measured by the flowmeter (Curve F₂), when a modification of the injection frequency Fᵢₙⱼ is made.

The curve E₁ is made up of a series of rectangular pulses the period whereof shifts from T₁ to T₂ when the frequency is modified. The curve E₂ is made up of two portions of straight lines invariant with time and offset from one another when Fᵢₙⱼ is modified. It can also be observed that, when the injection frequency Fᵢₙⱼ is modified, the variation of the flowrate measured by the flowmeter (curve F₁) is slowed down in comparison with the mean flowrate over an injection period, at the level of the injector (Curve E₂). It is the mechanical low-pass filter that causes this slowing-down. Taking account of the transfer function H₁ of the mechanical low-pass filter enables the variation of the flowrate measured by the flowmeter to be corrected and therefore speeded up to mathematically reconstitute a corrected mean flowrate (Curve F₂), by means of the correction circuit 8, which is close to the mean flowrate at the level of the injector (Curve E₂).

The injection device 1 can also comprise a regulation circuit of the pressure in the tank 2 and more particularly of the thrust pressure P_{gas}. Precise control of the thrust pressure does in fact enable the stability and control of the mean injected liquid flowrate to be improved, whatever the type of mean flowrate regulation chosen: both when a constant thrust pressure P_{gas} is maintained and the injector control parameters tᵢₙⱼ and Fᵢₙⱼ are varied, and when the thrust pressure P_{gas} is varied and the injector control parameters tᵢₙⱼ and Fᵢₙⱼ are kept constant.

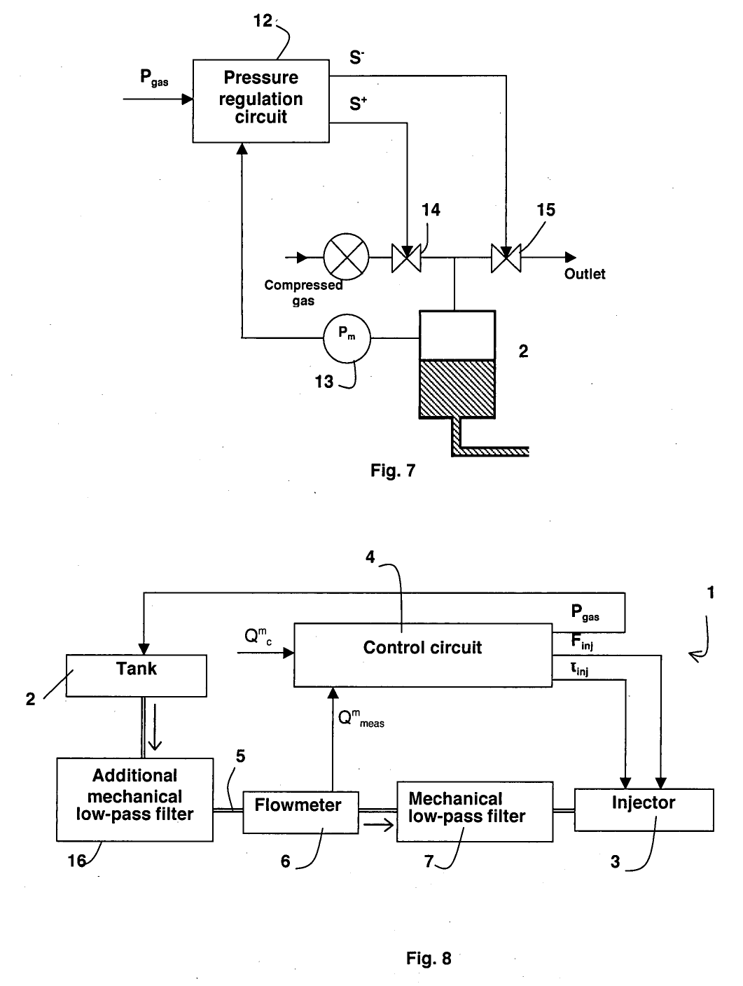

As illustrated in FIG. 7, a regulation circuit 12 comprises first and second inputs and preferably first and second outputs. The first input is connected to the output of the control circuit 4 associated with the tank 2, so that the control parameter P_{gas} represents the set-point of the pressure regulation circuit 12. The second input is connected to a measurement device 13 of the pressure Pₘ in the tank 2 such as a pressure sensor. The first and second outputs of the regulation circuit 12 are respectively connected to an inlet valve 14 and an outlet valve 15, in such a way as to control inlet and outlet of a compressed gas to and from the tank 2. The inlet valve 14, also called pressurizing valve, is thus open when the pressure Pₘ is lower than the set-point P_{gas}, whereas the outlet valve 15, also called removal valve, remains closed. The pressure upstream from the flowmeter then remains practically constant at the value regulated by the pressure regulation device 12.

The valves 14 and 15 are for example fast-acting piezoelectric valves or injectors like the one used for injecting the droplets into the chamber, the switching time of such valves being very fast, for example less than 1 ms. The valves are preferably controlled in Pulse Width Modulation (PWM) manner in such a way as to inlet or remove predetermined small quantities of gas to and from the tank 2. The pressure regulation circuit 12 comprises for example a difference logic circuit supplying an error signal between the set-point P_{gas} and the measured pressure Pₘ. The error signal is then corrected by two digital correctors respectively controlling the inlet and outlet valves.

The digital correctors in practice calculate the opening time of the valves from the difference between the pressure set-point and the pressure measured in the tank.

The digital correctors preferably depend on the gas volume situated above the precursor in liquid form contained in the tank 2, on the effective fluid conductances of the inlet and outlet valves, on the thrust gas pressure, on the pressure in the tank, on the pressure at the level of the outlet valve, and on the iteration frequency of the regulation loop. Optimization of the digital correctors according to these different parameters thus enables the thrust pressure of the liquid to be maintained very precisely and typically to within a few ppm.

Such an injection device enables discontinuous or mode pulsed injection of precursor droplets into the chamber to be obtained, with a variable droplet volume, in the following cases:
when the injector opening time tᵢₙⱼ is the only control parameter that is permanently modified to obtain a constant measured mean liquid flowrate,
when the injector opening time tᵢₙⱼ and the injection frequency Fᵢₙⱼ are the only two parameters that are permanently modified to obtain a constant measured mean liquid flowrate,
when the pressure in the tank is the only parameter that is permanently modified to obtain a constant measured mean liquid flowrate.

The invention is not limited to the embodiments described above. Thus, as represented in FIG. 8, an injection device as represented in FIG. 2 can also comprise an additional mechanical low-pass filter 16 arranged between the tank 2 and the flowmeter 6. Such a mechanical low-pass filter can be of the same type as the mechanical low-pass filter 7 arranged between the flowmeter 6 and the injector 3.

1-9. (canceled)

10. Device for injecting into a chamber at least one liquid precursor or one precursor in solution of an element to be deposited on a support arranged in the chamber, wherein it comprises:
at least one tank containing the precursor,
means for keeping the tank at a higher pressure than that of the chamber,
at least one injector connected to the tank,
a control circuit comprising outputs respectively connected to the tank and to the injector to control said pressure and/or the injection time and/or the injection frequency in such a way as to periodically inject droplets of precursor into the chamber,
a device for measuring the mean flowrate, arranged between the tank and the injector,
and a mechanical low-pass filter having a predetermined transfer function and arranged between the device for measuring the flowrate and the injector,
and wherein the control circuit comprises a regulation input connected to the output of the device for measuring the mean flowrate in such a way as to control said pressure and/or the injection time and/or injection frequency in such a way as to keep the mean flowrate at a predetermined set-point.

11. Device according to claim 10, wherein an additional mechanical low-pass filter is arranged between the tank and the device for measuring the flowrate.

12. Device according to claim 10, wherein the mechanical low-pass filter is formed by a pulse damper.

13. Device according to claim 10, wherein the mechanical low-pass filter is a restriction that is constituted by a portion of a pipe arranged between the tank and the injector, said portion having a smaller transverse cross-section than that of the rest of the pipe in such a way as to form a throttling.

14. Device according to claim 10, wherein the mechanical low-pass filter is constituted by a connection designed to form a buffer volume.

15. Device according to claim 10, wherein the control circuit comprises a correction circuit connected to the regulation input and taking account of the transfer function of the mechanical low-pass filter.

16. Device according to claim 10, comprising a pressure regulation circuit comprising at least first and second inputs respectively connected to the output of the control circuit associated with the tank and to a device for measuring the pressure in the tank.

17. Device according to claim 16, wherein the pressure regulation circuit comprises at least first and second outputs respectively connected to an inlet valve and an outlet valve respectively controlling inlet and outlet of a compressed gas to and from the tank.

18. Device according to claim 17, wherein the inlet and outlet valves are controlled in pulse width modulation.
